(19) United States
(12) Patent Application Publication
(10) Pub. No.: US 2026/0278239 A1
(43) Pub. Date: Sep. 17, 2026

(54) SYSTEMS AND METHODS FOR PROGRESSIVE TEXT ZOOM

(71) Applicant: Google LLC, Mountain View, CA (US)

(72) Inventor: Eric Aboussouan, New York, NY (US)

(21) Appl. No.: 19/077,133

(22) Filed: Mar. 12, 2025

(51) Int. Cl. G06F 40/106; G06F 3/0484; G06F 40/166

(52) U.S. Cl. CPC G06F 40/106; G06F 3/0484; G06F 40/166; G06F 2203/04806

(57) ABSTRACT

The technology provides a dynamic, scalable way to adjust the verbosity of text content of electronic documents and other digital materials. The technology applies a scaling concept for text, which can numerically measure the level of verbosity or detail in a document. This beneficially enables users to “zoom” in and out of the text via a user interface while reading. The amount of detail is readily adjustable to provide either less or more detail than the original content, which enhances readers'ability to efficiently navigate and comprehend large documents. The verbosity level of a document as a whole, or even for a specific section of a document can by adjusted. A verbosity level classifier is trained for use in a summarizer. The system can provide a dynamic, scalable approach to adjust the verbosity of the content.

### BACKGROUND

Information systems, such as the World Wide Web, allow users to find and access electronic documents quickly. However, users are presented with the challenge of efficiently navigating and comprehending large volumes of text in electronic documents. For instance, online content, such as news articles, scholarly articles and web pages, often present information in a dense and linear format, akin to a “wall of text.” This format may require readers to scroll and skim through extensive content to find specific information, which can be time-consuming and inefficient.

Traditional document structures in scholarly works, like titles, abstracts, and tables of contents, provide some hierarchical organization, but do not offer real-time, scalable navigation within the text itself. There are various tools that can be employed by a user, which can be helpful in certain situations but can also have significant drawbacks. By way of example, text summarization tools aim to condense a document into a shorter version while retaining key information. However, these tools often lack context sensitivity and may omit critical nuances. They may provide a static summary rather than a dynamic, scale-adjustable view of the text. Digital reading and note-taking apps allow users to highlight and annotate text, making it easier to navigate and refer back to key points. However, they may require users to navigate through the entire text. Certain academic papers explore methods for extracting relevant information from large text corpora. While they may contribute valuable insights, they often focus on data retrieval rather than user-friendly navigation and presentation of the text at different verbosity levels. Interactive e-books and educational platforms may use interactive texts where users can click on terms or sections to expand information. While this approach offers a certain level of engagement, this may be limited in scope and does not provide a scalable verbosity level across the entire document. Hyperlinked documents allow users to quickly jump to related information. However, this approach can disrupt the reading flow and does not offer a graduated scale of detail. And while document outlining tools can create outlines or collapsible sections of documents to allow for easier navigation of large texts, such tools may lack the ability to dynamically adjust the level of detail based on a verbosity scale.

### BRIEF SUMMARY

The technology provides a dynamic, scalable way to adjust the verbosity of text content. An aspect of the technology introduces the concept of “scale” for text, which can numerically measure the level of verbosity or detail in a document, thereby allowing users to “zoom” in and out of the text via a graphical user interface (GUI), gestures, etc., while reading. Users may quickly adjust the amount of detail they see, enhancing their ability to efficiently navigate and comprehend large documents.

One or both of abstractive summarization or extractive summarization may be employed as part of a neural network-based machine learning (ML) summarizer that has been trained to provide the verbosity adjustment. This is done while enhancing readability, comprehension, and navigation efficiency. In one scenario, the system may precompute different levels of summarization. In another scenario, the system may operate on the fly as the user selects a zoom level (e.g., a 10% or 50% zoom level, or a specific number of words such as 50 or 500 words, or more or less). In addition to verbosity, the system may apply other dimensions, such as context and/or nuance, in order to scale the textual verbosity. Moreover, zooming as a visualization component of the text presented to the user may occur across an entire document, or only in one part of a document while leaving other parts unchanged.

According to one aspect of the technology, a computer-implemented method for progressive text zooming is provided. The method comprises: obtaining, by a trained summarizer module of a computing system, an input electronic document, in which the input electronic document comprises at least one text segment. The method also includes obtaining, by the trained summarizer module, user input identifying a zoom level to be applied to at least a portion of the at least one text segment, and generating, by the trained summarize module from the at least the portion of the at least one text segment, one or more new text segments. The one or more new text segments each provide a given verbosity corresponding to the zoom level. The method further includes either storing the one or more new text segments in a non-transitory memory, or causing presentation of at least one of the one or more new text segments on a graphical user interface of a client device.

In one scenario, generating the one or more new text segments is performed according to at least one of extractive summarization or abstractive summarization. In an example, verbosity is a first register of speech, and generating the one or more new text segments is further performed according to at least one additional register of speech. Here, the at least one additional register of speech may be a jargon level or a formality level. In another example, the zoom level corresponding to the given verbosity is either derived directly from the at least one text segment or derived indirectly from an ontology associated with the electronic document. In a further example, generating the one or more new text segments is performed by the trained summarize module in real time in response to obtaining the user input.

In another scenario, generating the one or more new text segments is further based on at least one of contextual information associated with the electronic document or nuance information associated with the electronic document. Here, the contextual information may be identified through one or more of document metadata, section headers, citation patterns, technical terminology density, or domain classification, while nuance is identified through one or more of sentiment analysis, hedging language detection, uncertainty markers, or qualifier identification. The computing system may comprise the client device. In this case, causing presentation of at least one of the one or more new text segments on the graphical user interface includes preserving a general layout of the electronic document. Preserving the general layout of the electronic document may include maintaining a size or location of graphics adjacent to the at least one text segment while replacing the portion of the at least one text segment with a selected one of the one or more new text segments. Preserving the general layout of the electronic document may include presenting a selected one of the one or more new text segments in a same location as where the portion of the at least one text segment had been presented.

A given one of the one or more new text segments may have a zoom level greater than a baseline level of the portion of the at least one text segment, in which the given verbosity provides additional details about the portion of the at least one text segment. In another example, the trained summarizer module has been trained according to at least one of: (i) paired datasets of full documents and their summaries, (ii) multiple summary lengths for a same source, or (iii) a particular type of hierarchical attention mechanisms. The trained summarizer module may have been trained using section-specific features to learn one or more section-specific summarization patterns.

According to another aspect of the technology, a computing system is configured for progressive text zooming. The system comprises: memory configured to store a trained summarizer module of the computing system, and one or more processors operatively coupled to the memory. The one or more processors are configured to obtain, using the trained summarizer module, an input electronic document, in which the input electronic document comprises at least one text segment. The one or more processors are configured to obtain, using the trained summarizer module, user input identifying a zoom level to be applied to at least a portion of the at least one text segment. And the one or more processors are configured to generate, using the trained summarize module from the at least the portion of the at least one text segment, one or more new text segments. The one or more new text segments each provide a given verbosity corresponding to the zoom level. The computing system is configured to either store the one or more new text segments in the memory, or cause presentation of at least one of the one or more new text segments on a graphical user interface of a client device.

The trained summarizer module may comprise a trained large language model and/or a trained multi-modal model. In one scenario, generation of the one or more new text segments is performed according to at least one of extractive summarization or abstractive summarization. In an example, verbosity is a first register of speech, and generation of the one or more new text segments is further performed according to at least one additional register of speech. And in another scenario, generation of the one or more new text segments is performed by the trained summarize module in real time in response to obtaining the user input.

### BRIEF DESCRIPTION OF THE DRAWINGS

FIGS. 1-2 illustrate an example dynamic, progressive text zoom approach in accordance with aspects of the technology.

FIG. 3 illustrates an example of using a progressive text zoom system in accordance with aspects of the technology.

FIGS. 4A-C illustrate preserving a general document layout in accordance with aspects of the technology.

FIGS. 5A-B illustrate a zooming example that preserves the appearance of portions of the document, in accordance with aspects of the technology.

FIGS. 6A-B illustrate a system for use with aspects of the technology.

FIG. 7 illustrates an example method in accordance with aspects of the technology.

### DETAILED DESCRIPTION

The verbosity level of a document as a whole, or even for a specific section of a document (e.g., abstract, introduction or welcome section, chapter, detailed description, etc.), may not be inferred simply by looking at the text in a vacuum. This is because verbosity can be highly context dependent. Aspects of the technology involve training a verbosity level classifier for use in an ML-based summarizer. Upon training, the system is configured to provide a dynamic, scalable approach to adjust the verbosity of text content. This enables a user to “zoom” in and out of electronic documents, thus providing technical benefits and practical application for readability, comprehension, and/or navigation efficiency of such documents.

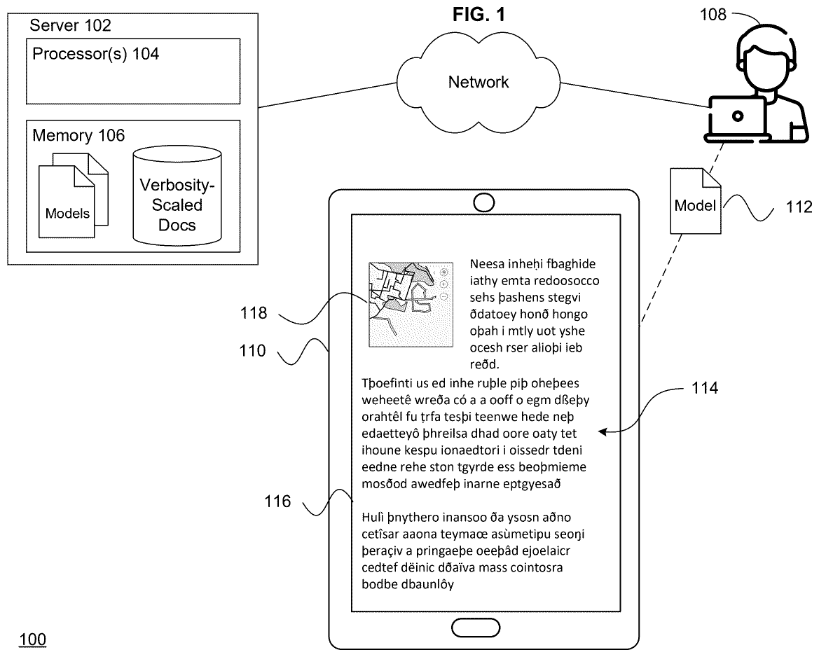

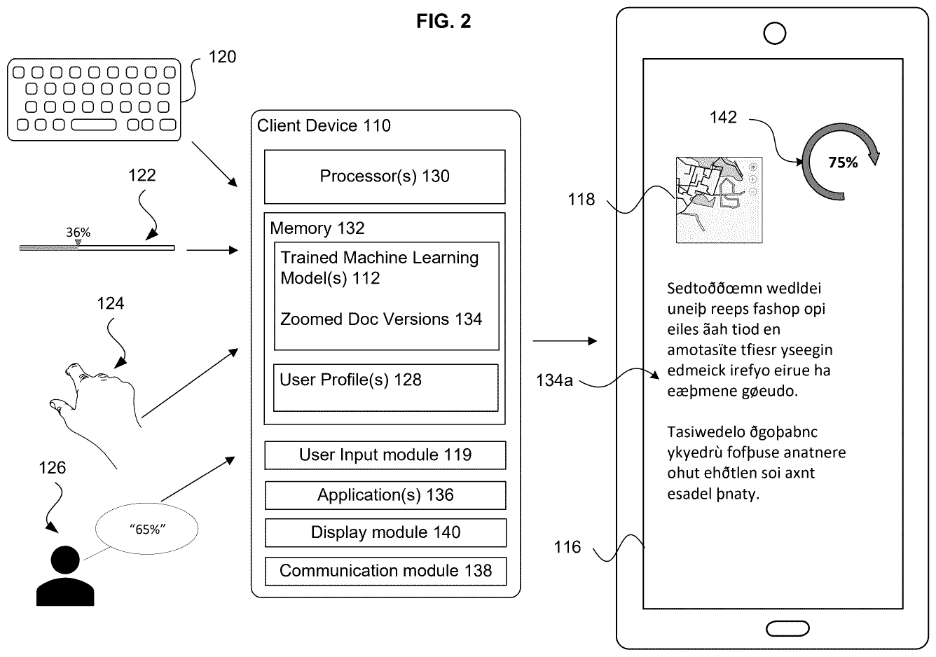

FIGS. 1-2 illustrate an example scenario. In particular, FIG. 1 illustrates an example involving a system 100 for processing user input and generating progressive text zooming of an electronic document. The system 100 may include a server 102 having one or more processors 104 and memory 106 for storing data. In one example, the memory 106 may store one or more trained models, which can include large language models (LLMs) multi-modal models (generally “models”), and/or a set of verbosity-scaled versions of one or more documents. A user 108 can query or otherwise search for documents via client device 110, which may be, e.g., a laptop or desktop computer, a tablet PC, a mobile phone or PDA, a smartwatch, head-mounted display or other wearable computing device, a smart home appliance, etc. User input is applied to a verbosity-trained model 112 that is configured to generate scaled versions of a given electronic document.

As discussed in detail below, the model 112 may be trained to provide at least one of abstractive summarization or extractive summarization. In one example, a single model may be trained to provide both summarization types, while in another example, different models may be fine-tuned or otherwise trained to provide only abstractive summarization or only extractive summarization. In this case, depending on a user query or other input, the system may select a particular model 112 to be employed. The trained model(s) 112 may be stored locally on the client device, and/or may be obtained from the models of the server 102.

As shown in FIG. 1, a given electronic document 114 is presented on GUI 116 of the client device 110. The given document may be a text-only document, or may include photos, icons or other graphics 118. Using trained model 112, the processing system of the client device 110 is able to generate summarized text present it to the user in GUI 116. As shown in FIG. 2, the client device 110 receives user input via a user input module 119. The user input may be obtained in one or more different ways. For instance, the user input may be obtained via an input mechanism 120 such as a keyboard, mouse, or trackpad, which may be a physical or virtual input mechanism. It may be obtained via a graphical tool 122 of the GUI 116, such as a slider bar that indicates a verbosity or zoom level/amount. It may also be obtained via a gesture 124 (e.g., a pinch-in gesture or a spread-out gesture), which may be detected using one or more cameras, a radio frequency ultra-wideband sensor, or other sensor type configured to detect gestures. The user input may also be detected using one or more microphones, for instance when the user verbalizes a zoom amount as shown at 126. Other inputs, which may be used alone or in combination with the above, include haptic feedback/controls (e.g., force touch, pressure sensitivity), eye tracking for zoom-level selection, a brain-computer interface (BCI), etc. Certain combinations include, but are not limited to: (i) voice+gesture (e.g., saying “zoom” while pinching), (ii) haptic input+motion (e.g., a pressure-sensitive scroll action), and (iii) eye tracking +voice command.

The zoom level (zoom amount) corresponds to relative verbosity. For instance, a 100% zoom level would be the nominal verbosity for a given text. One could zoom out (e.g., on the order of 50%), to get the gist of the text, and could zoom in (e.g., on the order of 150%) to be provided additional details. The additional details may be derived from footnotes, generatively created by a language model or multimodal model based on the complete text and/or other information (e.g., imagery, audio) associated with the text, extracted from another website, etc. Thus, the zoom level represents an inverse relationship with verbosity, whereby zooming in increases verbosity (presents more detail to the user), while zooming out decreases verbosity (presents less detail to the user). This can be expressed as a percentage where 100% represents the full original text (as a baseline), lower percentages represent more condensed versions, and higher percentages represent more detailed versions. Alternatively, zooming could be expressed along a scale (e.g., between 0 to 1). In this expression, 0.5 could represent the full original text, 0.0 could represent the minimum amount of detail, and 1.0 could represent the maximum amount of detail.

The generation of zoomed text may be initiated in response to the user input. However, in another scenario, the system may automatically generate zoomed-in text (e.g., 20-50%) or zoomed-out text (e.g., 120-150%) for the text of interest. This may occur when the user selects (e.g., highlights) a portion or section of text within a document. Automatic zooming may alternatively be done, e.g., in response to a user profile 128.

As shown in FIG. 2, the client device 110 includes one or more processors 130 and memory 132, and has at least one trained machine learning model 112. The memory 132 stores the model 112, and may also store the user profile(s) 128. The memory 132 may also store one or more zoomed versions 134 of an electronic document displayable on the GUI 116.

The client device 110 also includes one or more applications 136 (e.g., a browser app, a chat app, an email app, a notepad app, a document writing app, etc.), a communication module 138 (e.g., to communicate with server 102 and/or other client devices), and a display module 140 configured to generate the GUI 116, which can present one or more zoomed versions 134 of the electronic document. As illustrated, a first zoomed version 134a is presented to the user. This zoomed version may preserve the graphics 118 of the original electronic document, or may omit or modify some or all of the graphics 118. Also, the GUI 116 may include a zoom indicator 142, which may illustrate the zoom amount graphically and/or textually

### Example Systems and Methods

As noted above, one or more models (e.g., text-only or multi-modal models), such as verbosity-trained model 112, may be employed in the system. While there are a number of different possible system configurations, they each incorporate models configured to process and/or retrieve text. For instance, increasing the verbosity by zooming in on a selected text portion may include the model fetching or synthesizing text from one or more other sources (e.g., a web page, website, dictionary or stored document other than the text of interest).

According to one aspect, models based on the Transformer architecture may be employed, although other architectures may be used. The models may be decoder-only or encoder-decoder type models. The arrangements discussed herein can utilize one or more encoders and/or decoders. In one scenario, a first encoder may be configured to process textual information from, e.g., user input. A second encoder in a multi-modal model may be configured to process other information, such as graphical data associated with a document of interest and/or user profile data to aid in the visualization of the zoomed text. Alternatively or additionally, the encoders and/or decoders may be configured to handle audio input, multimedia input, form-based input, and/or other input modalities.

The technology described herein shows how to harness the attributes of neural network-based models for verbosity zooming. Verbosity, as discussed herein, encompasses the level of detail, elaboration and explanation present in text, which can be quantitatively measured and adjusted while preserving the core meaning of the content. By way of example only, a suitable neural network architecture is implementable via a computer program by processors of one or more computers in one or more locations. Generally, the system receives one or more input sequences from, e.g., a browser page, news or scientific article, or other electronic document, and processes the input sequence to transduce or otherwise convert the input sequence into an output sequence. The output sequence is a zoomed (in or out) version of the input sequence, with the text of the output sequence generated and presented to achieve a given verbosity level.

### Progressive Text Zoom Approaches

The technology provides a new technical approach for document summarization and text rewriting that generates progressive zooming in accordance with the verbosity or detail in a document. This can enhance the ability to efficiently navigate through, and to comprehend, various types of documents. Generally, a given document is processed using natural language processing (NLP) techniques to create different verbosity layers, each providing a different level of detail.

The technical approach introduces the concept of “scale” for text. The scale can numerically measure the level of verbosity or detail in a document, thereby allowing users to zoom in and out of the text. By doing so, readers are able to quickly adjust the amount of detail they see, enhancing their ability to efficiently navigate and understand large documents. One aspect involves text transformation. Here, as the user increases the verbosity level, a trained model is employed so that the displayed document dynamically expands to include more details, explanations, and content. Conversely, reducing the verbosity level involves the model condensing the text to present only key points and summaries. Changes in verbosity can be rendered by the model in real-time, allowing seamless navigation through different levels of detail. The trained model can also be finetuned for verbosity.

Verbosity scaling may be implemented by a summarizer, in particular by a neural network model trained on summarization. The summarizer may be trained to implement extractive summarization, which involves removing parts of a piece of text while maintaining the desired verbosity, and/or abstractive summarization, which involves rephrasing the parts of the text while maintaining the desired verbosity. Generally, the summarizer is configured to function by processing input text using one or more NLP techniques, applying learned patterns from training to generate different verbosity levels, maintaining semantic consistency across zoom levels, and implementing the zoom scale through one or both of extractive and abstractive summarization. The NLP techniques may include one or more of (i) dependency parsing to understand sentence structure, (ii) named entity recognition to preserve key concepts, (iii) semantic role labeling to maintain logical relationships, (iv) coreference resolution to handle pronouns and references, (v) text segmentation to identify coherent units, and (vi) topic modeling to maintain thematic consistency.

In one example, the summarizer may be run recursively to obtain a chosen verbosity level. In another example, the summarizer may be used to directly achieve specific levels of verbosity, e.g., in 5% or 10% increments (or with more or less granularity). The system may be configured so that a user can input a specific length of text (e.g., 100 words, 250 words, 500 words, or more or less), a specific amount of text (e.g., 2-3 sentences, a paragraph, or a page of text), or just highlight or otherwise select a section of text, and then the summarizer will output the corresponding amount of zoomed text having the desired verbosity level.

In one configuration, the system may precompute the different levels of summarization for a given electronic document. This can be done on the sentence level, or with any other desired unit of granularity (e.g., paragraph, phrase, etc.). Each sentence or other textual unit can have different zoom levels.

The summarizer may be trained by taking a corpus of articles or other documents, and having the summarize predict the abstract, the keywords section, or another specific section of the document. For an entire document, training may include using paired datasets of full documents and their summaries. The summarizer may train on multiple summary lengths for the same source, which is beneficial for verbosity-related training. Training may be performed for particular types of documents. For instance, for academic papers and similar texts, the training can be done using abstracts of different lengths. Moreover, the training can employ hierarchical attention mechanisms. For specific sections of a document, the system may train separate models for various section types. It may use section-specific features (e.g., technical terms for methods sections), and it can learn section-specific summarization patterns. In addition, the section-specific training may implement section-aware attention mechanisms. The training for entire documents and specific document sections may include assessment of whether generated verbosity-scaled documents accurately capture the desired verbosity by: comparing ROUGE or other scores for content preservation, evaluating semantic similarity metrics, analyzing section-specific evaluation metrics, and/or performing human evaluation of coherence.

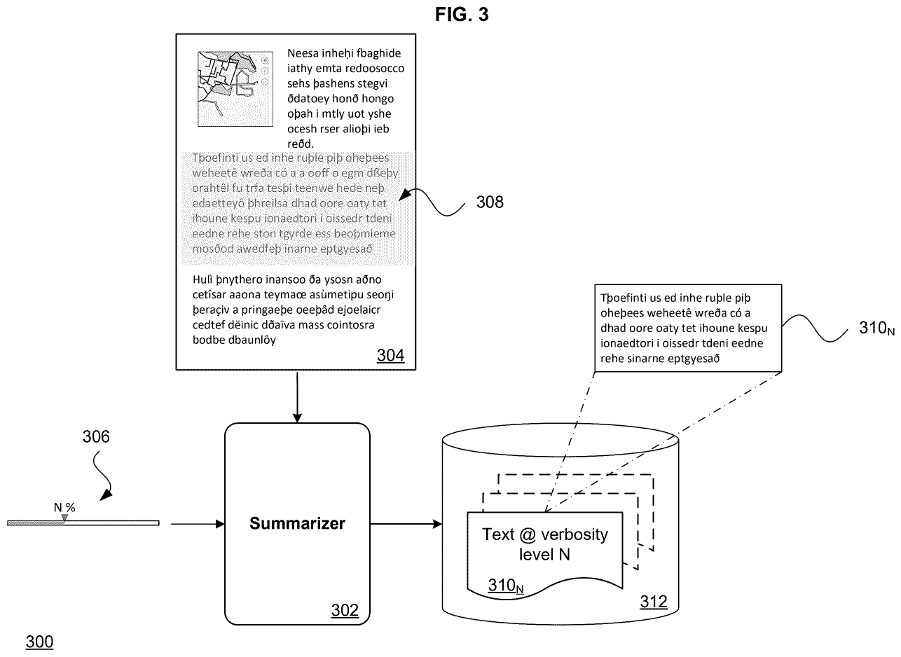

FIG. 3 illustrates how a progressive text zoom system may be employed with a client device. As shown in example 300, a neural network-based module, such as a trained summarizer 302, obtains an input document 304 and user input 306. The document 304 is an electronic document, which may be provided in a specific format (e.g., a PDF or RTF-type format), which may be part of a webpage, etc. The summarizer 302 also receives user input 306, such as described above with regard to any of inputs 120-126 of FIG. 2. As shown in this example, a certain portion 308 of the document (shaded in the figure for emphasis), such as a paragraph, the abstract, a particular technical section, etc., may be selected for verbosity zooming.

Based on the user input 306, the summarizer generates one or more text segments 310 having corresponding verbosity levels, which can be stored in memory 312. As shown in this example, the user input 306 identifies a verbosity level of N%, and the corresponding generated textual element is shown as 310_{N}. In one scenario the system may generate and store a set of textual elements 310 for the given input document 304 or the portion 308, each having a different verbosity or zoom level.

In one scenario, the verbosity-trained model (the summarizer) may be stored on and run by the client device. In another scenario, the model/summarizer may be maintained remotely. For example, it may be implemented via a browser extension/plugin or other app. In the browser scenario, when the user identifies the relevant text to zoom into or out of, the extension may automatically run, e.g., in conjunction with one or more processors on a back-end server, to generate the zoomed text and cause it to be presented on the GUI of the client device.

Other dimensions to consider in addition to verbosity include context and/or nuance. For instance, the context may correspond to the general subject matter of the document, and the document title may provide one or more keywords indicating the context. The system may train the summarizer based on the context found in the title or in other portions of the document. Context can be identified through one or more of document metadata, section headers, citation patterns, technical terminology density and/or domain classification. Context can be used for, e.g. adjusting the summarization style, preserving domain-specific terms, and maintaining technical accuracy, etc. Nuance can be identified through one or more of sentiment analysis, hedging language detection, uncertainty markers, qualifier identification, etc. Nuance can be used for, e.g., preserving important caveats, maintaining argumentative structure, and retaining important qualifications.

In addition to verbosity, other registers of speech can be applied when zooming into or out of a given segment of text. Examples of other registers include jargon level (e.g., from child to layperson to generalist to expert), vulgarity, formality, and other “persona” traits. For instance, using one or more such registers, the system may rephrase a given text segment to be more and more readable by a layperson. Thus, a scientific research paper regarding a highly specialized or esoteric topic (e.g., quantum tunnelling, astrodynamics, or holographic cryptography) can be made understandable to a person who may or may not have the same technical background as the author(s) of the paper. Speech registers can be incorporated into the systems discussed herein by, e.g., training separate models for different registers, implementing register-aware vocabulary selection, using controlled vocabulary lists for different expertise levels, maintaining register consistency across zoom levels, adapting technical terminology based on a target audience, and/or appropriately preserving formal/informal tone.

Note that the levels of verbosity can either be elicited/derived directly from the text or otherwise curated indirectly in the form of an ontology (e.g., manual curation). For example, an article in a scientific publication may have a strict and consistent structure and ontology specified by the editor of that publication. Moreover, in some arrangements, the level of zoom may be determined by trading off a text length penalty with the level of details present in the text. For instance, the higher the zoom level, the lower the text length penalty, and vice versa.

### Progressive Zoom Graphical Presentation

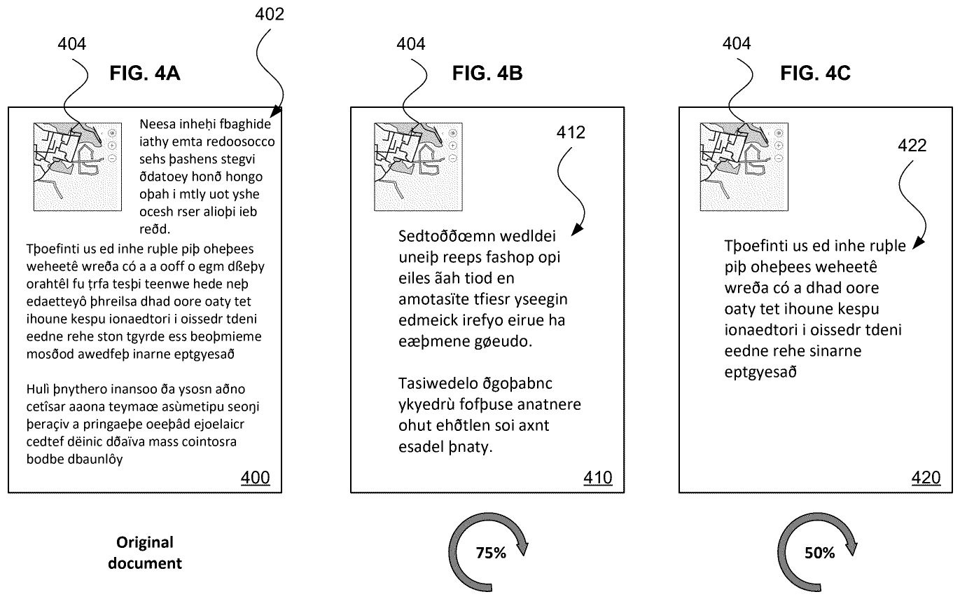

According to another aspect, as the user zooms in (or out), the GUI is configured to maintain the layout of the page or section of the document, while progressively increasing (or decreasing) the details shown. This may be done relative to cursor position, or for a selected region of text. FIGS. 4A-C illustrate examples of preserving the general document layout of, for instance, a web page. Here, FIG. 4A illustrates an original document (e.g., web page) 400, which includes original text 402 and an image or other graphics 404. FIG. 4B illustrates a first version 410 of the document at a first verbosity level (412), e.g., at a 75% verbosity level as shown. And FIG. 4C illustrates a second version 420 of the document at a second verbosity level (422), e.g., at a 50% verbosity level as shown. In these examples, the system can preserve the general layout in different ways. In one way, the image 404 is presented in the same location and at the same size in versions 410 and 420 as in the original document 400. In another way, the zoomed text 412 and 422 may be presented in the same general location (or an equivalent location) to where the corresponding text from which it was derived was located in the original document. This may be done without changing the size of the text.

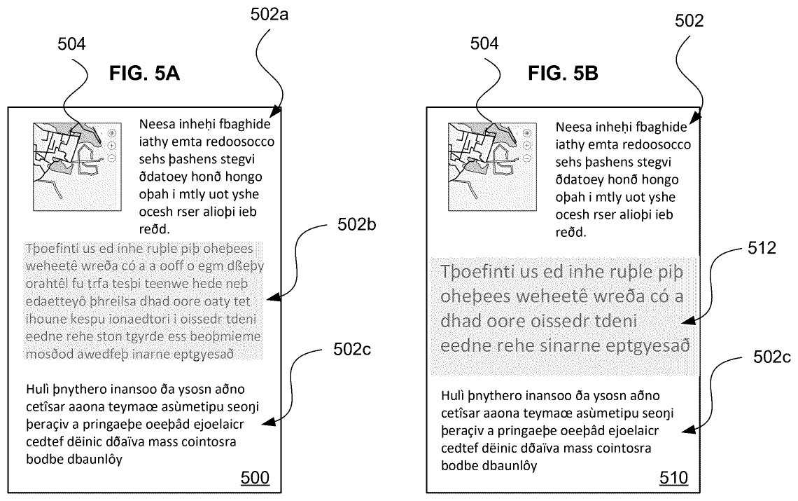

In different examples, the system is able to zoom into one part of the document, while leaving the rest of the document unchanged, or it may zoom in or out of the document as a whole. FIGS. 5A-B illustrate a zooming example that preserves the appearance of other portions of the document. Here, FIG. 5A illustrates an original document (e.g., web page) 500, which includes original text 502 and an image 504. In this example, the original text includes three sections: 502a, 502b and 502c. Section 502b is highlighted, as that is the text to be zoomed with verbosity scaling as discussed herein. FIG. 5B illustrates a version 510 of the document at a selected verbosity level for the section of interest, which is shows as section 512. As shown, this verbosity scaled section 512 summarizes or otherwise represents the content of section 502b, and is arranged in the same general portion of the document. The other text sections 502a and 502c, and the graphical image 504, remain unchanged from their presentation per the original document.

One way to zoom in on one part of the document is via a hyperlink. The text in the hyperlink can be seamlessly weaved into the main text. For instance, the hyperlink can be used to find the part of the document of interest, so that the system is able to zoom in (or out) on that. Another way is to select (e.g., highlight or encircle) the section of interest.

In another example, the zoom levels can be tied to what is presented to the user in the GUI. Here, the system may determine what information may fit into a window of the GUI that the user sees, and create a summarization around that point.

### Example Computing Architecture

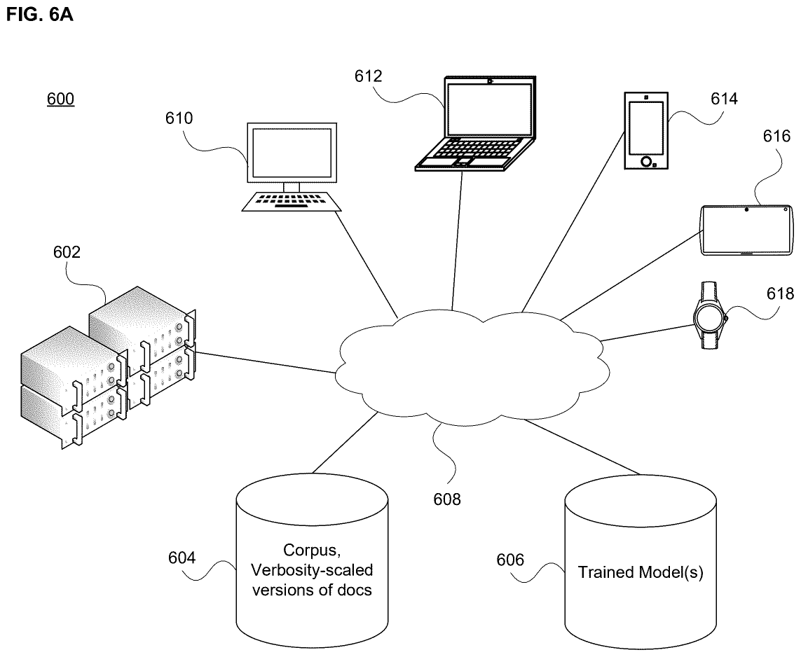

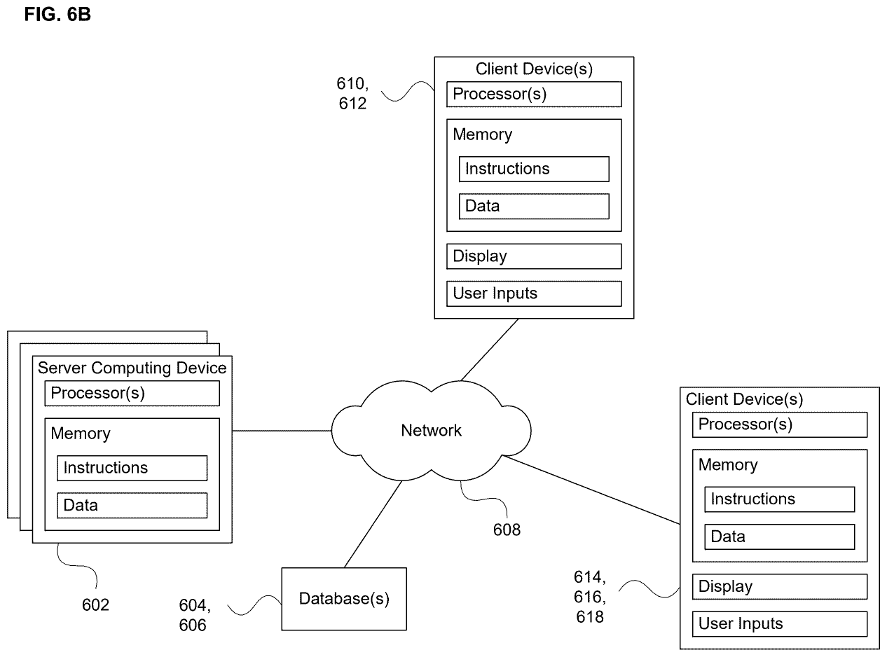

The verbosity-scaled progressive text zoom technology discussed herein may be trained and generate rewritten text based on received queries on one or more tensor processing units (TPUs), graphical processing units (GPUs), central processing units (CPUs) or other computing in accordance with the features disclosed herein. One example computing architecture is shown in FIGS. 6A and 6B. In particular, FIGS. 6A and 6B are pictorial and functional diagrams, respectively, of an example system 600 that includes a plurality of computing devices and databases connected via a network. For instance, computing device(s) 602 may be implemented as a cloud-based server system. Databases 604, and 606 may store, e.g., a corpus of documents used for training, versions of verbosity-scaled documents, and/or trained models (including LLMs or multimodal models such as the summarizer model(s)), respectively. The server system may access the databases via network 608. Client devices may include one or more of a desktop computer 610 and a laptop or tablet PC 612, for instance that present documents of interest and/or to view the progressive text zoom variations generated by the system in accordance with a given neural network arrangement as discussed here, which could be provided to the user via a web-based service, app or other program. Other client devices may include handheld devices including a personal communication device such as a mobile phone or PDA 614 or a tablet 616. Another example is a wearable device 618 such as a smartwatch (or head-mounted display device).

As shown in FIG. 6B, each of the computing devices 602 and 610-618 may include one or more processors, memory, data and instructions. Reference to “one or more processors” herein includes arrangements in which a set of processors may be configured to perform one or more operations. Any combination of such a set may perform individual operations or a group of operations. This may include two or more CPUs, GPUs and/or TPUs (or other hardware-based processors) or any combination thereof. It may also include configurations in which the processors have multiple processing cores. Therefore, reference to “one or more processors” does not require that all processors (or cores) in the set must each perform all of the operations. Rather, unless expressly stated, any one of the one or more processors (or cores thereof) may perform different operations when a set of operations is indicated, and different processors (or cores thereof) may perform specific operations, either sequentially or in parallel.

The memory stores information accessible by the one or more processors, including instructions, data, trained models, etc., which may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, GPUs, etc. Alternatively, each processor may be a dedicated device such as an ASIC or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 902. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, audio, and imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related client computing devices (e.g., 610-618) may communicate with a back-end computing system (e.g., server 602) via one or more networks, such as network 608. The network 608, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with any of the computing devices 610-618 via the network 608. The computing device 602 may implement a back-end server (e.g., a cloud-based image caption server), which receives information from desktop computer 610, laptop/tablet PC 612, mobile phone or PDA 614, tablet 616 or wearable device 618 such as a smartwatch or head-mounted display, and provides information (e.g., trained summarizer models, verbosity-scaled document versions, etc.) for use ty the client computing device(s).

An application used by the user, such as a web browser, document search system, word processing, social media or messaging application, etc., may utilize the technology by making a call to an API for a service that uses a summarizer to provide verbosity-scaled text segments. The service may be locally hosted on the client device such as any of client devices 610, 612, 614, 616 and/or 618, or remotely hosted such as by a back-end server such as computing device 602. In one scenario, the client device may provide the documents and GUI functionality, but relies on a separate service for the summarization. In another scenario, the client application and the summarizer model(s) may be provided by the same entity but associated with different services. In a further scenario, a client application may integrate with a third-party service for the baseline functionality of the application. And in another scenario, a third party or the client application may use a different service for the summarizer model(s). Thus, one or more neural network models may be provided by various entities, including an entity that also provides the client application, a back-end service that can support different applications, or an entity that provides such models for use by different services and/or applications.

Resultant information (e.g., one or more sets of verbosity-scaled text or other data derived from the approaches discussed herein may be shared by the server with one or more of the client computing devices. Alternatively or additionally, the client device(s) may maintain their own databases, models, etc. Thus, the client device(s) may locally process text for progressive scaling in accordance with the approaches discussed hereon. Moreover, the client device(s) may receive updated summarizer models (and/or other models) from the computing device 602 or directly from database 606 via the network 608.

### Exemplary Method

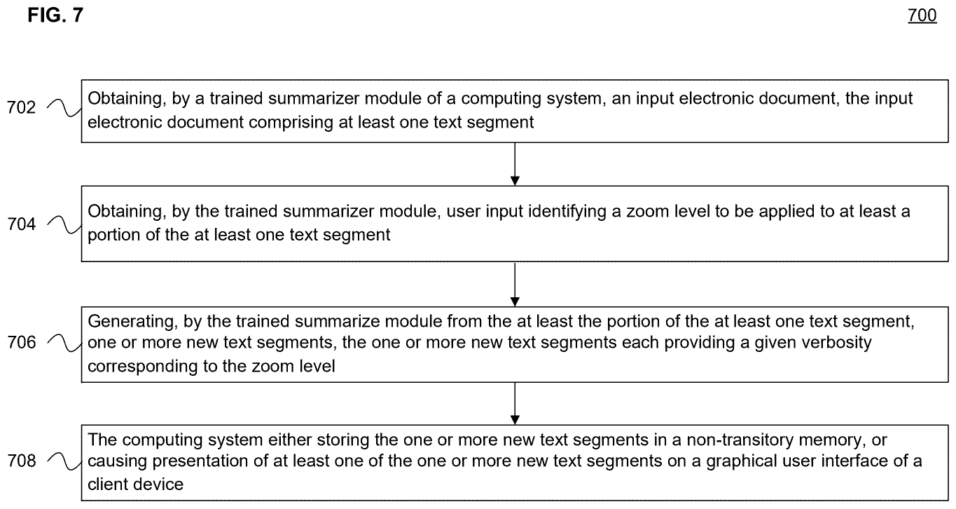

FIG. 7 illustrates an exemplary method 700 for progressive text zooming in view of the above discussion. At block 702, the method includes obtaining, by a trained summarizer module of a computing system, an input electronic document. The input electronic document comprises at least one text segment. At block 704, the method includes obtaining, by the trained summarizer module, user input identifying a zoom level to be applied to at least a portion of the at least one text segment. At block 706, the method includes generating, by the trained summarize module from the at least the portion of the at least one text segment, one or more new text segments. The one or more new text segments each provide a given verbosity corresponding to the zoom level. At block 708, the method includes the computing system either storing the one or more new text segments in a non-transitory memory, or causing presentation of at least one of the one or more new text segments on a graphical user interface of a client device.

The technology can be applied in many different scenarios and use cases. For instance, with regard to educational content, particularly for complex subjects, students can start with high-level summaries and gradually increase detail to understand deeper concepts. The approaches described herein can be integrated into e-learning platforms for adaptive learning. For research papers and scholarly articles, readers can vary the textual verbosity to quickly skim through the abstract and key findings, then zoom into sections for detailed methodologies and data. Similarly, for legal and technical documents, the technology enables lawyers, engineers, and other professionals to navigate quickly through large documents, focusing on relevant details as warranted. And for news articles and blogs, readers can adjust the verbosity to get a quick overview of news or dive deeper into comprehensive reporting.

In addition to aiding in document consumption the technology can be especially helpful while writing or editing documents. For example, in one scenario the author can write the text (at 100% zoom) and utilize the system to generate one or more other zoom levels. These zoom levels can be presented to users depending on a desired verbosity level, and can be used, e.g., to provide the abstract or a summary of the document. In another scenario, in addition to the original text (at 100% zoom), the author could also prepare one or more different verbosity levels (e.g., a synopsis at 10% verbosity, a medium-sized summary at 50% verbosity, and a more in-depth explanation of one or more aspects discussed in the text at 150% verbosity. For instance, the more in-depth explanation could include notes about a scene (such as if the text is a short story or a play), footnotes (such as to define terms or identify source materials), or other information that was not included in the main (100% zoom) text.

In addition to textual verbosity, the technology may be applied to video summarization. By way of example, for a given video (e.g., a 1-hour technical training video) the user could specify a time budget (e.g., 5 minutes, 10, minutes, 15 minutes, or more or less) and the system would then extractively construct a condensed video in the specified time budget that maintains the requisite “verbosity” for the video content. For instance, using multimodal processing, the system (e.g., the summarizer) may process visual features (e.g., at frame level), audio features (e.g., speech and other sounds), and text features (e.g., captions, transcripts, etc.). The system can apply one or more of hierarchical importance scoring, temporal coherence preservation, scene boundary detection, speech segment alignment, and caption-aware context selection to create one or more videos that scale the content (such as the text, audio and video) to fit a given time budget.

Technical benefits of the technology include, but are not limited, to the following. The technology provides enhanced user engagement and control, by providing an interactive and user-centric approach to reading, where users have control over the level of detail with which they engage. There can be improved comprehension and efficiency, because the technology facilitates better understanding by allowing readers to gradually increase detail, adapting to their comprehension levels. This saves time by enabling quick navigation to the desired level of detail via the GUI. The technology enables a customizable reading experience, because it supports different reading styles and needs, from skimming to in-depth study. This is particularly beneficial for readers with different expertise levels in a subject. Moreover, the technology has universal applicability, because it can be implemented across various digital platforms and document types, making it a versatile tool for online content.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method for progressive text zooming, the method comprising:
obtaining, by a trained summarizer module of a computing system, an input electronic document, the input electronic document comprising at least one text segment;
obtaining, by the trained summarizer module, user input identifying a zoom level to be applied to at least a portion of the at least one text segment;
generating, by the trained summarize module from the at least the portion of the at least one text segment, one or more new text segments, the one or more new text segments each providing a given verbosity corresponding to the zoom level; and
the computing system either storing the one or more new text segments in a non-transitory memory, or causing presentation of at least one of the one or more new text segments on a graphical user interface of a client device.

2. The method of claim 1, wherein generating the one or more new text segments is performed according to at least one of extractive summarization or abstractive summarization.

3. The method of claim 1, wherein verbosity is a first register of speech, and generating the one or more new text segments is further performed according to at least one additional register of speech.

4. The method of claim 3, wherein the at least one additional register of speech is a jargon level or a formality level.

5. The method of claim 1, wherein the zoom level corresponding to the given verbosity is either derived directly from the at least one text segment or derived indirectly from an ontology associated with the electronic document.

6. The method of claim 1, wherein generating the one or more new text segments is performed by the trained summarize module in real time in response to obtaining the user input.

7. The method of claim 1, wherein generating the one or more new text segments is further based on at least one of contextual information associated with the electronic document or nuance information associated with the electronic document.

8. The method of claim 7, wherein:
the contextual information is identified through one or more of document metadata, section headers, citation patterns, technical terminology density, or domain classification; and
nuance is identified through one or more of sentiment analysis, hedging language detection, uncertainty markers, or qualifier identification.

9. The method of claim 1, wherein the computing system comprises the client device, and causing presentation of at least one of the one or more new text segments on the graphical user interface includes preserving a general layout of the electronic document.

10. The method of claim 9, wherein preserving the general layout of the electronic document includes maintaining a size or location of graphics adjacent to the at least one text segment while replacing the portion of the at least one text segment with a selected one of the one or more new text segments.

11. The method of claim 9, wherein preserving the general layout of the electronic document includes presenting a selected one of the one or more new text segments in a same location as where the portion of the at least one text segment had been presented.

12. The method of claim 1, wherein a given one of the one or more new text segments has a zoom level greater than a baseline level of the portion of the at least one text segment, in which the given verbosity provides additional details about the portion of the at least one text segment.

13. The method of claim 1, wherein the trained summarizer module was trained according to at least one of: (i) paired datasets of full documents and their summaries, (ii) multiple summary lengths for a same source, or (iii) a particular type of hierarchical attention mechanisms.

14. The method of claim 1, wherein the trained summarizer module was trained using section-specific features to learn one or more section-specific summarization patterns.

15. A computing system configured for progressive text zooming, the system comprising:
memory configured to store a trained summarizer module of the computing system; and
one or more processors operatively coupled to the memory, the one or more processors being configured to:
obtain, using the trained summarizer module, an input electronic document, the input electronic document comprising at least one text segment;
obtain, using the trained summarizer module, user input identifying a zoom level to be applied to at least a portion of the at least one text segment; and
generate, using the trained summarize module from the at least the portion of the at least one text segment, one or more new text segments, the one or more new text segments each providing a given verbosity corresponding to the zoom level;
wherein the computing system is configured to either store the one or more new text segments in the memory, or cause presentation of at least one of the one or more new text segments on a graphical user interface of a client device.

16. The computing system of claim 15, wherein the trained summarizer module comprises a trained large language model.

17. The computing system of claim 15, wherein the trained summarizer module comprises a trained multi-modal model.

18. The computing system of claim 15, wherein generation of the one or more new text segments is performed according to at least one of extractive summarization or abstractive summarization.

19. The computing system of claim 15, wherein verbosity is a first register of speech, and generation of the one or more new text segments is further performed according to at least one additional register of speech.

20. The computing system of claim 15, wherein generation of the one or more new text segments is performed by the trained summarize module in real time in response to obtaining the user input.
